(19) United States
(12) Patent Application Publication
(10) Pub. No.: US 2014/0322390 A1
(43) Pub. Date: Oct. 30, 2014

(54) GLUTEN-FREE DRY MIX COMPOSITION

(71) Applicant: Lucca Foods, LLC, Salem, MA (US)

(72) Inventors: Stefanie Papanastasiou, Salem, MA (US); Debra Papanastasiou, Salem, MA (US)

(73) Assignee: Lucca Foods, LLC., Salem, MA (US)

(21) Appl. No.: 14/345,572

(22) PCT Filed: Sep. 19, 2012
(86) PCT No.: PCT/US2012/056012

§ 371 Date: Mar. 18, 2014

Related U.S. Application Data
(60) Provisional application No. 61/536,384, filed on Sep. 19, 2011.

(51) Int. Cl. A21D 10/00

(52) U.S. Cl. CPC A21D 10/005
USPC 426/87; 426/622; 426/549

(57) ABSTRACT

Provided herein are gluten-free dry mix compositions, gluten-free and gluten-reduced food products, and methods for making said food products.

### RELATED APPLICATIONS

This application claims the benefit under 35 U.S.C. §119(e) of U.S. provisional patent application Ser. No. 61/536,384, filed Sep. 19, 2011, the contents of which is incorporated herein by reference in its entirety.

### BACKGROUND OF THE INVENTION

Gluten is a protein composite found in foods processed from wheat and related species, including barley and rye. It imparts elasticity to dough, helping it to rise and to keep its shape, and often giving the final product a chewy texture. Between 0.5 and 1.0 percent of people in the United States are sensitive to gluten due to Celiac Disease (Consensus Development Panel on Celiac Disease. National Institutes of Health (NIH) (2005)).

When people with Celiac Disease eat foods containing gluten, their immune system responds by damaging tiny fingerlike protrusions, called villi. Villi lining the small intestines are responsible for the absorption of nutrients into the bloodstream. If villi become damaged or destroyed and are unable to absorb nutrients, a person becomes malnourished, irrespective of the quantity of the food consumed. Symptoms associated with Celiac Disease include recurring abdominal bloating and pain, chronic diarrhea, weight loss, fatigue, delayed growth, and failure to thrive in infants.

The only medically accepted treatment for Celiac Disease is to follow a gluten-free diet, eliminating virtually all foods made from grains that contain gluten. It is difficult for individuals following such a diet to find gluten-free options, for example, at restaurants and local convenience stores. Many of the commercially-available gluten-free food options made using gluten-free flour substitutes lack the pleasurable organoleptic properties of foods made using grains that contain gluten (e.g., wheat flour-based bread). Food products prepared using existing all-purpose gluten-free flour substitutes have, more often than not, a strong bitter or sour aftertaste, and/or poor texture.

### SUMMARY OF THE INVENTION

Described herein are compositions, and related methods, that provide for gluten-free or gluten-reduced food products having, in many embodiments, organoleptic properties that are the same or substantially the same as their gluten-containing food product counterparts. Food products (e.g., bread, crackers, pizza dough) made using existing all-purpose gluten-free flour substitutes typically require additional ingredients, depending on the type of food, to compensate for a particular desired property of the food. For example, it is often necessary to include additional amounts of gum (thickening agent) to a food product, the amount of the gum varying depending on the food (e.g., less for a cookie, more for pie crust). An otherwise simple recipe can become a complex experiment in trying to determine what mixture of gluten-free ingredients will achieve a final food product comparable to its gluten-containing counterpart.

Provided herein, in certain embodiments, is a 1:1 gluten-free dry mix substitute for gluten-containing flours (e.g., wheat, barley, and/or rye flour), which imparts into the food product pleasurable organoleptic properties (e.g., mouthfeel) comparable to the properties of counterpart gluten-containing food products.

In some aspects, provided herein are gluten-free dry mix compositions comprising white rice flour, sweet rice flour, sorghum flour, potato starch, cornstarch, and xanthan gum. In some aspects, provided herein are gluten-free dry mix compositions comprising white rice flour, sweet rice flour, sorghum flour, potato starch, cornstarch, and guar gum. In some embodiments, the gluten-free dry mix compositions further comprise ascorbic acid. In some embodiments, the gluten-free dry mix compositions further comprise ginger.

In some embodiments, the white rice flour is present in an amount of about 60% to about 70% weight/weight (w/w) of the dry mix composition. In some embodiments, the white rice flour is finely ground into a white rice powder.

In some embodiments, the sweet rice flour, sorghum flour, potato starch, and cornstarch are collectively present in an amount of about 30% to about 45% w/w of the dry mix composition.

In some embodiments, the xanthan gum is present in an amount ranging between about 0.5% w/w and about 5% w/w or of about 1% w/w of the dry mix composition.

In some aspects, provided herein are gluten-free dry mix compositions consist essentially of white rice flour in an amount of about 60% to about 70% w/w of the dry mix composition; sweet rice flour; sorghum flour, potato starch, and cornstarch in an amount of about 30% to about 45% w/w of the dry mix composition; xanthan gum in an amount of about 1% w/w of the dry mix composition; ascorbic acid; and ginger. In other aspects, provided herein are gluten-free dry mix compositions consist essentially of white rice flour in an amount of about 60% to about 70% w/w of the dry mix composition; sweet rice flour; sorghum flour, potato starch, and cornstarch in an amount of about 30% to about 45% w/w of the dry mix composition; guar gum in an amount of about 1% w/w of the dry mix composition; ascorbic acid; and ginger.

In some embodiments, the dry mix compositions do not comprise tapioca or tapioca flour. In some embodiments, the dry mix compositions do not comprise a bean flour.

In some aspects, provided herein are methods of preparing any of the gluten-free dry mix compositions described herein, the methods comprising blending white rice flour, sweet rice flour, sorghum flour, potato starch, cornstarch, and xanthan gum. In other aspects, provided herein are methods of preparing any of the gluten-free dry mix compositions described herein, the methods comprising blending white rice flour, sweet rice flour, sorghum flour, potato starch, cornstarch, and guar gum. In yet other aspects, provided herein are methods of preparing any of the gluten-free dry mix compositions described herein, the methods comprising blending white rice flour in an amount of about 60% to about 70% w/w of the dry mix composition; sweet rice flour, sorghum flour, potato starch, and cornstarch in an amount of about 30% to about 45% w/w of the dry mix composition; xanthan gum in an amount of aboul 1% w/w of the dry mix composition; ascorbic acid; and ginger. In still other aspects, provided herein are methods of preparing any of the gluten-free dry mix compositions described herein, the methods comprising blending white rice flour in an amount of about 60% to about 70% w/w of the dry mix composition; sweet rice flour, sorghum flour, potato starch, and cornstarch in an amount of about 30% to about 45% w/w of the dry mix composition; guar gum in an amount of about 1% w/w of the dry mix composition; ascorbic acid; and ginger.

In some aspects, provided herein are gluten-free food products comprising any of the gluten-free dry mix compositions described herein. In other aspects, provided herein are gluten reduced food products comprising any of the gluten-free dry mix compositions described herein.

In some aspects, provided herein are methods of preparing a food product based on a recipe that requires wheat, barley or rye flour and at least one other ingredient, said methods comprising combining any of the gluten-free dry mix compositions described herein with the at least one other ingredient in the recipe, wherein the wheat, barley, or rye flour ingredient is substituted with an equivalent amount of the gluten-free dry mix composition, and wherein the prepared food product is gluten-free.

In some aspects, provided herein are methods of preparing a food product based on a recipe that requires wheat, barley or rye flour and at least one other ingredient, said method comprising combining white rice flour, sweet rice flour, sorghum flour, potato starch, cornstarch, and xanthan gum or guar gum with the at least one other ingredient in the recipe, wherein the wheat, barley, or rye flour ingredient is substituted with an equivalent amount of white rice flour, sweet rice flour, sorghum flour, potato starch, cornstarch, and xanthan gum, and wherein a gluten-free food product is prepared. In some aspects, provided herein are methods of preparing a food product based on a recipe that requires wheat, barley or rye flour and at least one other ingredient, said method comprising combining white rice flour, sweet rice flour, sorghum flour, potato starch, cornstarch, and xanthan gum or guar gum with the at least one other ingredient in the recipe, wherein the wheat, barley, or rye flour ingredient is substituted with an equivalent amount of white rice flour, sweet rice flour, sorghum flour, potato starch, cornstarch, and guar gum, and wherein a gluten-free food product is prepared.

In some aspects, provided herein are methods of preparing a food product based on a recipe that requires wheat, barley or rye flour and at least one other ingredient, said method comprising combining white rice flour in an amount of about 60% to about 70% w/w of the dry mix composition; sweet rice flour, sorghum flour, potato starch, and cornstarch in an amount of about 30% to about 45% w/w of the dry mix composition; xanthan gum in an amount of about 1% w/w of the dry mix composition; ascorbic acid; and ginger with the at least one other ingredient in the recipe, wherein the wheat, barley, or rye flour ingredient is substituted with an equivalent amount of white rice flour in an amount of about 60% to about 70% w/w of the dry mix composition; sweet rice flour, sorghum flour, potato starch, and cornstarch in an amount of about 30% to about 45% w/w of the dry mix composition; xanthan gum (or guar gum) in an amount of about 1% w/w of the dry mix composition; ascorbic acid; and ginger; and wherein a gluten-free food product is prepared. In other aspects, provided herein are methods of preparing a food product based on a recipe that requires wheat, barley or rye flour and at least one other ingredient, said method comprising combining white rice flour in an amount of about 60% to about 70% w/w of the dry mix composition; sweet rice flour, sorghum flour, potato starch, and cornstarch in an amount of about 30% to about 45% w/w of the dry mix composition; xanthan gum in an amount of about 1% w/w of the dry mix composition; ascorbic acid; and ginger with the at least one other ingredient in the recipe, wherein the wheat, barley, or rye flour ingredient is substituted with an equivalent amount of white rice flour in an amount of about 60% to about 70% w/w of the dry mix composition; sweet rice flour, sorghum flour, potato starch, and cornstarch in an amount of about 30% to about 45% w/w of the dry mix composition; or guar gum in an amount of about 1% w/w of the dry mix composition; ascorbic acid; and ginger; and wherein a gluten-free food product is prepared.

In some embodiments, the additional ingredients not listed in the recipe are excluded from the gluten-free food product and the amount of each ingredient in the recipe is not altered. In some embodiments, the additional ingredients not listed in the recipe are excluded from the gluten-reduced food product and the amount.of each ingredient in the recipe is not altered.

In some aspects, provided herein are gluten-free food products prepared by any of the methods described herein. In other aspects, provided herein are gluten-reduced food products prepared by any of the methods described herein.

In some embodiments, the food product is selected from the group consisting of angel food cake, biscotti, biscuits, Boston cream pie, bread pudding, bread, dinner roll, dough, doughnuts, brownie, bundt cake, cakes (e.g., wedding cakes), cinnamon rolls, cookie, cheese cake, chips, cracker, croissants, cupcakes, danish, eclair, florentine, French pastries, fruit cakes, fudge, coffee cakes, lemon squares, liqueur cake, loaf, muffin, noodles, pasta, pie dough, puff pastry turnover, pancake, pie, pineapple upside down cake, pizza dough, pretzels, quiche, quick bread, red velvet cake, sticky bun, strudel, stuffing, tart, tiramisu, torte, tres leche cake and trifle.

In some aspects, provided herein are gluten-reduced food products comprising any of the gluten-free dry mix compositions described herein and one or more additional gluten-containing ingredients.

In some aspects, provided herein are prepackaged gluten-free food product kits comprising any of the gluten-free dry mix compositions described herein and a recipe or directions for obtaining a recipe for preparing a food product using the gluten-free dry mix composition. In other aspects, provided herein are prepackaged gluten-reduced food product kits comprising any of the gluten-free dry mix compositions described herein and a recipe or directions for obtaining a recipe for preparing a food product using the gluten-free dry mix composition.

In some embodiments, the kits further comprise at least one additional ingredient that is listed in the recipe.

In some aspects, provided herein are gluten-free dry mix compositions comprising rice flour, sorghum flour, potato starch, cornstarch, and xanthan gum (or guar gum).

### DETAILED DESCRIPTION OF THE EMBODIMENTS

Described herein are gluten-free dry mix compositions, which can be used to substitute gluten-containing flours, such as wheat, rye, and barley flour. The inventive gluten-free dry mix compositions may contain a mixture of gluten-free flour(s), starch(es), and thickening agent(s). In certain embodiments, the gluten-free dry mix compositions comprise rice flour (which in certain embodiments comprises both white rice flour), sweet rice flour, sorghum flour, potato starch, cornstarch, and xanthan gum. In certain embodiments, the inventive compositions comprise or consist essentially of white rice flour (e.g., superfine white rice flour), sweet rice flour, sorghum flour, potato starch, cornstarch, xanthan gum, ascorbic acid, and ginger. In certain embodiments, the amount of white rice flour in a gluten-free dry mix composition is about 60% to about 70% w/w of the composition, and the remaining components are present in an amount of about 30% to about 45% w/w of the composition. For example, in certain embodiments of the compositions provided herein, sweet rice flour, sorghum flour, potato starch, cornstarch, and xanthan gum are present in an amount of about 30% to about 45% w/w of the composition. As another example, sweet rice flour, sorghum flour, potato starch, cornstarch, xanthan gum, ascorbic acid, and ginger may be present in an amount of about 30% to about 45% w/w of the composition. In particular embodiments, the amount of xanthan gum is about 1% w/w of the composition.

Also disclosed herein relate are gluten-free or gluten-reduced food products and methods of preparing such food products. Also disclosed are prepackaged gluten-free or gluten-reduced food product kits comprising any one of the gluten-free dry mix compositions described herein, a recipe for preparing a food product using the gluten-free dry mix composition, and, optionally, at least one additional ingredient (without or without gluten) that is listed in the recipe.

I. Definitions

“Ascorbic acid” is a naturally occurring organic compound with antioxidant properties. It is a white solid but impure samples can appear yellowish. It dissolves well in water to give mildly acidic solutions. Ascorbic acid is one form of vitamin C. As used herein, ascorbic acid includes its sodium, potassium, and calcium salts.

“Cornstarch” refers to a gluten-free starch of the corn (maize) grain obtained from the endosperm of the corn kernel. Cornstarch (or corn starch) can be used as a thickening agent in certain of the embodiments described herein.

“Dry mix composition” refers to a substantially dry (no added water) mixture of edible ingredients, for example, flours, starches, gums, and the like. In some embodiments, the dry mix compositions described herein are gluten-free or gluten-reduced. A “gluten-free” composition refers to a composition substantially without (essentially free of) gluten protein. In some embodiments, a gluten-free dry mix composition and the ingredients/components used to prepare a composition provided herein are obtained from gluten-free facilities; that is, such facilities do not manufacturn or use equipment that comes into contact with products that contain gluten. In certain embodiments, a dry mix composition may have trace amounts of gluten protein-(e.g., detectable but not able to be readily quantified). If, for example, the ingredients used to prepare an inventive dry mix composition are processed in a facility that is not gluten-free, cross-contamination from gluten-containing ingredients to intended gluten-free ingredients can occur, resulting in supposedly gluten-free ingredients having trace amounts of gluten. It is understood that such dry mix compositions having trace amounts of gluten may be used to prepare gluten-reduced food products, but they should not be used to prepare gluten-free products. Even trace amounts of gluten protein can be detrimental to certain individuals with Celiac Disease or those with a sensitivity or allergy to gluten.

“Equivalent amount” refers to a 1:1 substitution of one ingredient for another. For example, if a recipe requires 1 cup (about 1 cup) of wheat flour, an equivalent amount of the gluten-free dry mix composition is 1 cup (about 1 cup).

“Food product” refers to a food, beverage, ingredient thereof or nutritional supplement that can be consumed to provide nutritional support for the body. A food product typically contains essential nutrients, such as carbohydrates, fats, proteins, vitamins, and/or mineral. A food product encompasses, but is not limited to, natural (unmodified) foods, organic foods, and composite foods made of one or more ingredients. A food product can be raw or cooked (e.g., baked, grilled, or fried). Any one of the food products described herein can be or comprise one or more fruit, vegetable, seed, grain, meat, fish, poultry, dairy product (e.g., milk, yogurt, cheese, etc.), or the like. Any one of the food products may also comprise added flavoring agents or sweeteners and the like. They may also include antioxidant food additives, such as ascorbic acid (i.e., vitamin C).

“Ginger” (also referred to as root ginger) means the rhizome of the plant Zingiber officinale and preparations made therefrom (e.g., ginger powder, ginger extract, etc.). Ginger, including for example root ginger or ginger powder (e.g., 100% ginger or a mixture of ginger and other spices), may optionally be present in any one of the gluten-free or gluten-reduced dry mix compositions described herein. Ginger can affect yeast activity, for example, it can increase yeast activity. In some instances, the addition of ginger to a bread recipe can affect how high the bread rises. Other members of this ginger plant family are turmeric, cardamom, and galangal, and in some embodiments, turmeric, cardamom, or galangal may be present in a dry mix composition. In some embodiments, cinnamon is present in a dry mix composition. Cinnamon, like ginger, affects yeast; however, cinnamon typically decreases the activity of yeast.

“Gluten” refers to an amorphous ergastic protein composite found in the endosperm of most cereals. It constitutes about 80% of the proteins contained in wheat and is composed of the proteins gliadine and glutenine. Gluten is responsible for the elasticity of kneaded dough which allows it to be leavened, as well as the ‘chewiness’ of baked products such as bagels. Gluten is found in most cereals (e.g., wheat, rye and barley) and products made with those cereals. Rice, soybean (soya), maize (corn), buckwheat, and sunflower seeds, for example, naturally do not contain gluten.

“Gluten-free diet” refers to a diet that excludes foods containing gluten protein. In some embodiments, a gluten-free diet may also be an organic diet.

“Gluten-free flour” refers to a powder or powder-like substance made of cereal grains, other seeds, or roots that are essentially free of gluten protein. The gluten-free flours used herein can be naturally gluten free or processed to eliminate its gluten content. As defined herein, “flour” encompasses ground or milled substances that are not fine; they can be coarse or even contain particles having a particle size, for example, of about 1 to about 100 microns or more, about 1 to about 50 microns, or about 50 to about 100 microns. In contrast, “powder,” “finely-ground powder,” or “superfine powder” refers to substances that are not coarse and can contain particles having a particle size, for example, of less than 50 microns, less than 25 microns, or less than 1 micron. In some embodiments, a distinction is made between, for example, milled white rice flour (e.g., particles greater than 1 micron) and finely-ground or superfine white rice powder (e.g., particles less than 1 micron). As used herein, “ particle size” refers to the largest characteristic dimension (i.e. of a line passing through the geometric center of the particle e.g., diameter) that can be measured along any orientation of a particle (e.g., a polymer particle).

“Gluten-free food product” refers to a food product that does not contain (i.e. is essentially free of) gluten protein. In some embodiments, in addition to the gluten-free dry mix compositions described herein, gluten-free food products may comprise other gluten-free ingredients. Examples of other gluten-free ingredients include corn, potatoes, rice, and tapioca (derived from cassava, also referred to herein as tapioca flour), amaranth, arrowroot, millet, montina, lupin, quinoa, sorghum (jowar), taro, teff, chia seed, yam, beans, soybean, and nut flours, buckwheat, and gram flour, derived from chickpeas. In some embodiments, the gluten-free dry mix compositions described herein exclude tapioca/tapioca flour. In some embodiments, the compositions described herein exclude bean and/or nut flours. Examples of bean flours include garbanzo bean flour (e.g., chickpea, gram, chana, besan, or cici flour), pinto bean flour, fava bean flour, navy bean flour, or other legume-based flour.

“Gluten-free ingredient” refers to any edible substance that forms or can be used to form part of a mixture (e.g., dry mixture) and that does not contain gluten protein. “Gluten-containing ingredient” refers to any edible substance that forms or can be used to form part of a mixture and that does contain (at least some) gluten protein.

“Gluten-reduced food product” refers to a food product that contains a reduced amount of gluten protein, relative to a food product made without taking measures to reduce the gluten content. For example, a gluten-reduced food product may contain any one of the gluten-free dry mix compositions described herein and additionally contain one or more ingredient that is not gluten-free. A gluten-reduced food product may also comprises a dry mix composition containing trace amounts of gluten protein.

“Guar gum” refers to a polysaccharide composed of the sugars galactose and mannose. Guar gum can be used as an emulsifier and/or as a stabilizer.

“Organic” refers to food products that are produced using methods that do not involve modern synthetic inputs such as synthetic pesticides and chemical fertilizers, no not contain genetically modified organisms, and are not processed using irradiation, industrial solvents, or chemical food additives. Any one of the food products (including, food, beverages, ingredients, dry mix compositions, and the like) may be organic or made with at least one organic component. In certain embodiments, organic food products or ingredients may meet the requirements of The Organic Foods Production Act (OFPA) of 1990 (Title 21 of P.L. 101-624, the Food, Agriculture, Conservation, and Trade Act of 1990) and/or may be certified as organic by an accredited certifying agent in the jurisdiction in which the food product or ingredient is produced and/or sold.

“Organoleptic properties” refers to the aspects of food or other substances as experienced by the senses, including taste, sight, smell, and touch. “Mouthfeel” refers to a product's physical and chemical interaction in the mouth and is evaluated from initial perception on the palate, to first bite, through mastication to swallowing and aftertaste. The gluten-free or gluten-reduced food products provided herein in certain embodiments have at least some organoleptic properties and mouthfeel comparable to their gluten-containing counterparts. For example, the organoleptic properties, including mouthfeel, of a chocolate chip cookie prepared with the gluten-free dry mix composition described herein may share substantially the same organoleptic properties of a chocolate chip cookie prepared following the same recipe but substituting wheat flour for the inventive gluten-free dry mix composition. The two cookies may look substantially the same, taste substantially the same, smell substantially the same, and/or feel substantially the same.

“Potato starch” refers to a gluten-free starch that is extracted from potatoes (e.g., potato varieties with high starch content). The cells of the root tubers of the potato plant contain starch grains (leucoplasts). To extract the starch, the potatoes are crushed; the starch grains are released from the destroyed cells. The starch is then washed out and dried to powder.

“Prepackaged” food products or kits are those that are wrapped or packaged before marketing. Any one of the gluten-free or gluten-reduced dry mix compositions provided herein may be prepackaged. In instances wherein the inventive dry mix compositions are part of a prepackaged kit, such a kit can comprises a recipe or direction to obtain a recipe and/or one or more ingredients described in the recipe. A “recipe” means a set of instructions that describes how to prepare or make a food product, typically including a list of ingredients and step-by-step directions.

“Sorghum flour” refers to a gluten-free powder made from sorghum millet grain.

“Sweet rice flour” refers to a gluten-free powder made from high-starch, short-grain rice. Sweet rice flour can be used as a thickening agent.

“Wheat” means any Triticum species, including, but not limited to, T. aestivuin, T. monococcum, T. tauschii and T. turgidum. Thus, as used herein, the term “wheat” means any type of wheat including, but is not limited to, any cultivated wheat, any wild wheat, any wheat species, any intra- and inter-species wheat crosses, all wheat varieties, all wheat genotypes and all wheat cultivars. Cultivated wheats include, but are not limited to, einkom, durum and common wheats. “Barley” means a cereal grain derived from the annual grass Hordeum vulgare. “Rye” means a cereal grain (Secale cereale) that originated from either S. montanum or S. anatolicum and is closely related to wheat and barley. Wheat, barley, and rye each contain gluten protein.

“White rice flour” refers to a gluten-free powder made from polished rice (bran and germ removed). White rice flour can be used as a thickening agent. White rice may contain high levels of protein. In some embodiments, the white rice flour is superfine or finely-ground white rice flour (e.g., Authentic Foods™ White Rice Flour Superfine).

“Xanthan gum” refers to a high molecular weight polysaccharide gum produced by a pure-culture fermentation of a carbohydrate with Xanthomonas campestris, purified, for example, by recovery with ethanol or isopropanol, dried and milled. It contains D-glucose and D-mannose as the dominant hexose units, along with D-glucuronic acid and pyruvic acid, and may be prepared as the sodium, potassium or calcium salt. Xanthan gum, a natural thickener, may be used to add volume and viscosity to bread and other gluten-free baked goods.

II. Compositions and Methods

Certain aspects of the invention disclosed herein relate to gluten-free dry mix compositions comprising at least one of and in certain embodiments all of white rice flour, sweet rice flour, sorghum flour, potato starch, and a gum. In some embodiments, the gum is a guar gum, while in preferred embodiments, it is xanthan gum. In certain embodiments, the compositions further comprise cornstarch. In some embodiments, the compositions further comprise ascorbic acid and/or ginger. In particular embodiments, provided herein are gluten-free or gluten-reduced dry mix compositions comprising or consisting essentially of white rice flour, sweet rice flour, sorghum flour, potato starch, xanthan gum, ascorbic acid, and ginger. Any one of these compositions may be suitable for use as a 1:1 substitute for gluten-containing flours, such as wheat, barley, and/or rye flour. Food products, related methods of preparing such food products, and prepackaged kits comprising the inventive dry mix compositions are also described herein.

In certain embodiments, the amount of white rice flour in a dry mix composition is about 50% to about 80% w/w of the composition. In some embodiments, the white rice flour is present in an amount of about 50% to about 70% w/w, about 50% to about 60% w/w, about 60% to about 80% w/w, about 60% to about 70% w/w, or about 70% to about 80% w/w of the composition. In other embodiments, the white rice flour is present in an amount of about 50%, about 55%; about 60%, about 65%, about 70%, about 75% or about 80% w/w of the composition. In certain embodiments, the white rice flour is superfine or finely-ground (referred to herein as white rice powder).

In some embodiments, the collective amount of sweet rice flour, sorghum flour, and potato starch in a dry mix composition is about 20% to about 50% w/w of the composition. In some embodiments, sweet rice flour, sorghum flour, and potato starch are present in a collective amount of about 20% to about 45%, about 20% to about 40%, about 20% to about 35%, about 20% to about 30%, about 20% to about 25%, about 25% to about 50%, about 25% to about 45%, about 25% to about 40%, about 25% to about 35%, about 25% to about 30%, about 30% to about 50%, about 30% to about 45%, about 30% to about 40%, about 30% to about 35%, about 35% to about 50%, about 35% to about 45%, about 35% to about 40%, about 40% to about 50%, or about 45% to about 50% w/w of the composition. In other embodiments, sweet rice flour, sorghum flour, and potato starch are present in a collective amount of about 20%, about 25%, about 30%, about 35%, about 40%, about 45%, or about 50% w/w of the composition. This collective amount, in some embodiments, includes cornstarch. In some embodiments, this collective amount also includes ascorbic acid and ginger.

In certain embodiments, the amount of gum in the dry mix composition is about 0.5% to about 5% w/w of the composition. In some embodiments, the gum is present in an amount of about 0.5% to about 4%, about 0.5% to about 3.5%, about 0.5% to about 3%, about 0.5% to about 2.5%, about 0.5% to about 2%, about 0.5% to about 1.5%, about 0.5% to about 1%, about 1% to about 5%, about 1% to about 4%, about 1% to about 3.5%, about 1% to about 3%, about 1% to about 2.5%, about 1% to about 2%, about 1% to about 1.5%, about 1.5% to about 5%, about 1.5% to about 4.5%, about 1.5% to about 4%, about 1.5% to about 3.5%, about 1.5% to about 3%, about 1.5% to about 2.5%, about 1.5% to about 2%, about 2% to about 5%, about 2% to about 4.5%, about 2% to about 4%, about 2% to about 3.5%, about 2% to about 3%, about 2% to about 2.5%, about 3% to about 5%, about 3% to about 4.5%, about 3% to about 4%, about 3% to about 3.5%, about 3.5% to about 5%, about 3.5% to about 4.5%, about 3.5% to about 4%, about 4% to about 5%, about 4% to about 4.5%, or about 4.5% to about 5% w/w of the compositions. In some embodiments, the gum is present in an amount of about 0.5%, about 1%, about 1.5%, about 2%, about 2.5%, about 3%, about 3.5%, about 4%, about 4.5%, or about 5% w/w of the composition. In some embodiments, the gum is xanthan gum.

In certain embodiments, the amount of sweet rice flour in a dry mix composition is about 5% to about 20% w/w of the composition. In some embodiments, sweet rice flour is present in an amount of about 5% to about 15%, about 5% to about 10%, about 10% to about 20%, about 10% to about 15%, or about 15% to about 20% w/w of the composition. In some embodiments, sweet rice flour is present in an amount of about 5%, about 6%, about 7%, about 8%, about 9%, about 10%, about 11%, about 12%, about 13%, about 14%, about 15%, about 16%, about 17%, about 18%, about 19%, or about 20% w/w of the composition.

In certain embodiments, the amount of sorghum flour in a dry mix composition is about 5% to about 20% w/w of the composition. In some embodiments, sorghum flour is present in an amount of about 5% to about 15%, about 5% to about 10%, about 10% to about 20%, about 10% to about 15%, or about 15% to about 20% w/w of the composition. In some embodiments, sorghum flour is present in an amount of about 5%, about 6%, about 7%, about 8%, about 9%, about 10%, about 11%, about 12%, about 13%, about 14%, about 15%, about 16%, about 17%, about 18%, about 19%, or about 20% w/w of the composition.

In certain embodiments, the amount of potato starch in a dry mix composition is about 5% to about 20% w/w of the composition. In some embodiments, potato starch is present in an amount of about 5% to about 15%, about 5% to about 10%, about 10% to about 20%, about 10% to about 15%, or about 15% to about 20% w/w of the composition. In some embodiments, potato starch is present in an amount of about 5%, about 6%, about 7%, about 8%, about 9%, about 10%, about 11%, about 12%, about 13%, about 14%, about 15%, about 16%, about 17%, about 18%, about 19%, or about 20% w/w of the composition.

In certain embodiments, the amount of cornstarch in a dry mix composition is about 2% to about 10% w/w of the composition. In some embodiments, cornstarch is present in an amount of about 2% to about 8%, about 2% to about 6%, about 2% to about 4%, about 4% to about 10%, about 4% to about 8%, about 4% to about 6%, about 6% to about 10%, about 6% to about 8%, or about 8% to about 10% w/w of the composition. In some embodiments, cornstarch is present in an amount of about 2%, about 3%, about 4%, about 5%, about 6%, about 7%, about 8%, about 9%, or about 10% w/w of the composition.

In certain embodiments, the amount of ascorbic acid in a dry mix composition is about 0.1% to about 1% or about 0.1% to about 0.5% w/w of the composition. In some embodiments, ascorbic acid is present in an amount of about 0.1%, about 0.15%, about 0.2%, about 0.25%, about 0.3%, about 0.35%, about 0.4%, about 0.45%, or about 0.5% w/w of the composition.

In certain embodiments, the amount of ginger in a dry mix composition is about 0.1% to about 1% or about 0.1% to about 0.5% w/w of the composition. In some embodiments, ginger is present in an amount of about 0.1%, about 0.15%, about 0.2%, about 0.25%, about 0.3%, about 0.35%, about 0.4%, about 0.45%, or about 0.5% w/w of the composition.

In certain embodiments, tapioca flour is excluded from the dry mix compositions described herein. In certain embodiments, bean flour is excluded from the dry mix compositions described herein.

Other aspects provided herein relate methods of preparing a food product having a recipe that requires wheat, barley and/or rye flour and at least one other ingredient, the methods comprising combining the gluten-free dry mix composition of any one of the embodiments described herein with at least one other ingredient in the recipe. In some embodiments, a gluten-free dry mix composition is used to substitute for wheat, barley, and/or rye flour ingredients in the recipe. In other embodiments, a gluten-free dry mix composition substitutes for only a portion of the wheat, barley, or rye flour ingredients in the recipe. In such embodiments, a gluten-reduced (rather than a gluten-free) food product is prepared. For example, in a recipe requiring 2 cups of wheat flour, 1 of the 2 cups of wheat flour can be substituted with (replaced by) any one of the gluten-free dry mix compositions described herein.

Still other aspects provided herein relate to methods of preparing a food product based on a recipe that requires wheat, barley and/or rye flour and at least one other ingredient, the methods comprising combining white rice flour, sweet rice flour, sorghum flour, potato starch, and a gum (e.g., xanthan gum) with at least one other ingredient in the recipe. In some embodiments, the methods further comprise combining cornstarch. In some embodiments, the methods further comprise combining ascorbic acid and/or ginger.

In certain embodiments, additional ingredients not listed in the recipe are excluded during preparation of the food product (and excluded from the final food product) and the amount of each ingredient in the recipe is not altered. It is known to one of ordinary skill in the art that when gluten-free flour blends or flours, such as sorghum flour, are used in place of, e.g., wheat flour, it is often necessary to alter other ingredients in the recipe to compensate for the properties that are lost or negatively affected by omitting gluten. For example, extra oil or shortening may be necessary to impart moisture to the wheat-free food product, an extra egg or two may be required to improve smoothness and crumb structure, or extra baking powder and/or baking soda may be necessary to boost rising properties. Such “altered” amounts and/or types of ingredients may not be necessary with the gluten-free or gluten-reduced dry mix compositions of certain embodiments described herein. Certain embodiments of the inventive compositions may be used as a direct 1:1 substitution (about 1:1) for gluten-based flours, such as wheat, barley, and/or rye flour, without the addition of extra ingredients/amounts of required ingredients.

Yet other aspects provided herein relate to gluten-free or gluten-reduced food products. Gluten-free food products may comprise any one of the gluten-free dry mix compositions provided herein or may comprises the ingredients used to make the gluten-free dry mix compositions. Such food products may be gluten-free or substantially gluten-free. Gluten-reduced food products may comprise any one of the gluten-free dry mix compositions provided herein or may comprise ingredients used to make the gluten-free dry mix compositions, and additionally, one or more ingredients comprising gluten. Examples of gluten-free or gluten-reduced food products include, but are not limited to, angel food cake, biscotti, biscuits, Boston cream pie, bread pudding, bread, dinner roll, dough, doughnuts, brownie, bundt cake, cakes, cinnamon rolls, cookie, cheese cake, chips, cracker, croissants, cupcakes, danish, eclair, florentine, French pastries, fruit cakes, fudge, coffee cakes, lemon squares, liqueur cake, loave, muffin, noodles, pasta, pie dough, puff pastry turnover, pancake, pie, pineapple upside down cake, pizza dough, pretzels, quiche, quick bread, red velvet cake, sticky bun, strudel, stuffing, tart, tiramisu, torte, tres leche cake, trifle, and wedding cake.

Aspects provided herein also relate to prepackaged dry mixes comprising any one of the gluten-free dry mix compositions described herein, optionally also including one or more additional ingredients (e.g., gluten-free ingredients), and a recipe or directions for obtaining a recipe for preparing a food product using the gluten-free dry mix composition and the additional ingredients.

The function and advantage of these and other embodiments of the present invention may be more fully understood from the examples below. The following examples, while illustrative of certain embodiments of the invention, do not exemplify the full scope of the invention.

### EXAMPLES

### Example 1

### Chocolate Chip Cookies

Ingredients: 2¼ cups gluten-free dry mix composition (finely-ground white rice flour, sweet rice flour, potato starch, sorghum flour, xanthan gum, cornstarch, ascorbic acid, and ginger), 1 teaspoon baking soda, 1 teaspoon salt, 1 cup (2 sticks) butter, softened, ¾ cup granulated sugar, ¾ cup packed brown sugar, 1 teaspoon vanilla extract, 2 large eggs, 2 cups (12-oz. pkg.) NESTLÉ® TOLL HOUSE® Semi-Sweet Chocolate Morsels, 1 cup chopped nuts. Directions: Preheat oven to 375° F. Combine flour, baking soda and salt in small bowl. Beat butter, granulated sugar, brown sugar and vanilla extract in large mixer bowl until creamy. Add eggs, one at a time, beating well after each addition. Gradually beat in flour mixture. Stir in morsels and nuts. Drop by rounded tablespoon onto ungreased baking sheets. Bake for 9 to 11 minutes or until golden brown. Cool on baking sheets for 2 minutes; remove to wire racks to cool completely.

### Example 2

### Sour Cream Coffee Cake

Ingredients: ½ cup butter, 1 cup sugar, 1 cup sour cream, 1 teaspoon vanilla, 2 eggs, 2 cups gluten-free dry mix composition (finely-ground white rice flour, sweet rice flour, potato starch, sorghum flour, xanthan gum, cornstarch, ascorbic acid, and ginger), 1 teaspoon baking powder, and 1 teaspoon baking soda. Nut topping: ½ teaspoon cinnamon, ½ cup chopped walnuts, and ¼ cup firmly packed brown sugar. Directions: spoon ½ of the cake batter into the pan. Sprinkle with ½ of the nut topping. Spoon in remaining batter and top with remaining nut topping. Bake at 375° F. for 30-45 minutes depending on pan size.

### Example 3

### Carrot Cake

Ingredients: 2 cups gluten-free dry mix composition (finely-ground white rice flour, sweet rice flour, potato starch, sorghum flour, xanthan gum, cornstarch, ascorbic acid, and ginger), 2 cups sugar, 1 teaspoon baking powder, 1 teaspoon baking soda, 1 teaspoon ground cinnamon, 3 cups of finely shredded carrot, 1 cup cooking oil, and 4 eggs. Directions: preheat oven to 350° F. In a bowl, combine flour, sugar, baking powder, baking soda, and cinnamon. Add carrot, oil, and eggs. Beat with an electric mixer until all ingredients are combined. Pour into two greased and floured 9×1½ inch round baking pans. Bake in a 350° F. oven for 20-35 minutes. Cool on wire rack for 10 minutes. Remove cakes from pan and cool thoroughly.

For pineapple carrot cake, prepare as above except add one 8¼ ounce can undrained crushed pineapple and ½ cup coconut with carrot. Bake about 40 min.

For raisin-nut carrot cake, prepare as above, except stir in ¼ cup raisins or currants and ½ cup chopped nuts into batter.

While several embodiments of the invention have been described and illustrated herein, those of ordinary skill in the art will readily envision a variety of other means and structures for performing the functions and/or obtaining the results or advantages described herein, and each of such variations, modifications and improvements is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, provided that such features, systems, materials and/or methods are not mutually inconsistent, is included within the scope of the present invention.

In the claims (as well as in the specification above), all transitional phrases or phrases of inclusion, such as “comprising,” “including,” “carrying,” “having,” “containing,” “composed of,” “made of,” “formed of,” “involving” and the like shall be interpreted to be open-ended, i.e. to mean “including but not limited to” and, therefore, encompassing the items listed thereafter and equivalents thereof as well as additional items. Only the transitional phrases or phrases of inclusion “consisting of” and “consisting essentially of” are to be interpreted as closed or semi-closed phrases, respectively. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified. Thus, as a non-limiting example, a reference to “A and/or B” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” will refer to, the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood, unless otherwise indicated, to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements that the phrase “at least one” refers to, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In cases where the present specification and a document incorporated by reference and/or referred to herein include conflicting disclosure, and/or inconsistent use of terminology, and/or the incorporated/referenced documents use or define terms differently than they are used or defined in the present specification, the present specification shall control.

What is claimed is:

1. A gluten-free dry mix composition, comprising:
(a) white rice flour;
(b) sweet rice flour;
(c) sorghum flour;
(d) potato starch;
(e) cornstarch; and
(f) xanthan gum or guar gum.

2. The gluten-free dry mix composition of claim 1 or 21, further comprising ascorbic acid.

3. The gluten-free dry mix composition of claim 1 or 21, further comprising ginger.

4. The gluten-free dry mix composition of any one of claims 1-3, wherein the white rice flour is present in an amount of about 60% to about 70% w/w of the dry mix composition.

5. The gluten-free dry mix composition of any one of claims 1-4, wherein the white rice flour is finely ground into a white rice powder.

6. The gluten-free dry mix composition of any one of claims 1-5, wherein the sweet rice flour, sorghum flour, potato starch, and cornstarch are collectively present in an amount of about 30% to about 45% w/w of the dry mix composition.

7. The gluten-free dry mix composition of any one of claims 1-6, wherein the xanthan gum is present in an amount ranging between about 0.5% w/w and about 5% w/w or of about 1% w/w of the dry mix composition.

8. A gluten-free dry mix composition, consisting essentially of:
(a) white rice flour in an amount of about 60% to about 70% w/w of the dry mix composition;
(b) sweet rice flour, sorghum flour, potato starch, and cornstarch in an amount of about 30% to about 45% w/w of the dry mix composition;
(c) xanthan gum or guar gum in an amount of about 1% w/w of the dry mix composition;
(d) ascorbic acid; and
(e) ginger.

9. The gluten-free dry mix composition of any one of claims 1-8, wherein the dry mix composition does not comprise tapioca or tapioca flour.

10. The gluten-free dry mix composition of any one of claims 1-8, wherein the dry mix composition does not comprise a bean flour.

11. A method of preparing the gluten-free dry mix composition of claim 1 or claim 8, comprising blending components (a)-(f) or (a)-(e), respectively.

12. A gluten-free or gluten reduced food product comprising the gluten-free dry mix composition of any one of claims 1-11.

13. A method of preparing a food product based on a recipe that requires wheat, barley or rye flour and at least one other ingredient, said method comprising combining the gluten-free dry mix composition of any one of claims 1-10 with the at least one other ingredient in the recipe, wherein the wheat, barley, or rye flour ingredient is substituted with an equivalent amount of the gluten-free dry mix composition, and wherein the prepared food product is gluten-free.

14. A method of preparing a food product based on a recipe that requires wheat, barley or rye flour and at least one other ingredient, said method comprising combining components (a)-(f) of claim 1 or components (a)-(e) of claim 8 with the at least one other ingredient in the recipe, wherein the wheat, barley, or rye flour ingredient is substituted with an equivalent amount of components (a)-(f) of claim 1 or components (a)-(e) of claim 8, and wherein a gluten-free food product is prepared.

15. The method of claim 13 or 14, wherein additional ingredients not listed in the recipe are excluded from the gluten-free food product and wherein the amount of each ingredient in the recipe is not altered.

16. A gluten-free or gluten reduced food product prepared by the method of any one of claims 13-15.

17. The gluten-free food product of claim 12 or claim 16, wherein the food product is selected from the group consisting of: angel food cake, biscotti, biscuits, Boston cream pie, bread pudding, bread, dinner roll, dough, doughnuts, brownie, bundt cake, cakes, cinnamon rolls, cookie, cheese cake, chips, cracker, croissants, cupcakes, danish, eclair, florentine, French pastries, fruit cakes, fudge, coffee cakes, lemon squares, liqueur cake, loaf, muffin, noodles, pasta, pie dough, puff pastry turnover, pancake, pie, pineapple upside down cake, pizza dough, pretzels, quiche, quick bread, red velvet cake, sticky bun, strudel, stuffing, tart, tiramisu, torte, tres leche cake, trifle, and wedding cake.

18. A gluten-reduced food product comprising the gluten-free dry mix composition of any one of claims 1-10 and one or more additional gluten-containing ingredients.

19. A prepackaged gluten-free or gluten reduced food product kit comprising the gluten-free dry mix composition of any one of claims 1-10 and a recipe or directions for obtaining a recipe for preparing a food product using the gluten-free dry mix composition.

20. The kit of claim 19, wherein the kit further comprises at least one additional ingredient that is listed in the recipe.

21. A gluten-free dry mix composition, comprising:
(a) rice flour;
(b) sorghum flour;
(c) potato starch;
(d) cornstarch; and
(e) xanthan gum or guar gum.
